(19) United States
(12) Patent Application Publication
(10) Pub. No.: US 2016/0375829 A1
(43) Pub. Date: Dec. 29, 2016

(54) Display System For Vehicles, In Particular Commercial Vehicles

(71) Applicant: MEKRA LANG GMBH & CO. KG, Ergersheim (DE)

(72) Inventors: Werner LANG, Ergersheim (DE); Michael WITZKE, Ansbach (DE); Peter GEISSENDÖRFER, Gallmersgarten (DE); Sebastian HEGER, Markt Nordheim (DE); Simon DEFFNER, Flachslanden (DE); Jaap-Jan SNEL, Ergersheim (DE)

(73) Assignee: MEKRA LANG GMBH & CO. KG

(21) Appl. No.: 15/189,860

(22) Filed: Jun. 22, 2016

(30) Foreign Application Priority Data
Jun. 23, 2015 (DE) 102015008042.3

(51) Int. Cl. B60R 1/00; H04N 5/232; G06K 9/00

(52) U.S. Cl. CPC B60R 1/00; G06K 9/00805; H04N 5/23293; B60R 2300/802; B60R 2300/8093

(57) ABSTRACT

A display system for environment regions of a vehicle having at least an image capturing unit, which is arranged on the vehicle in a housing that protrudes outward from the vehicle, a processing unit, a display unit providing and outputting vehicle environment information captured by the image capturing unit to the driver of the vehicle, and a capturing device for capturing the position of the image capturing unit, thereby enabling the driver to identify the position of the image capturing unit with regard to the vehicle environment.

### BACKGROUND OF THE INVENTION

### 1. Field of the Invention

The present invention relates to a display system for vehicles, in particular commercial vehicles, and particularly to a display system comprising an image capturing unit for the usage for commercial vehicles.

### 2. Description of the Related Art

[In motor vehicles, dependent on the type of motor vehicle, e.g. motor cycles, motor vehicles for the carriage of passengers, motor vehicles for the carriage of goods etc., so-called fields of view are legally prescribed, which fields of view have to be displayed by a system for indirect view, and have to be permanently visible for a person seated on the driver's seat via the system for indirect view. Usually, these systems for indirect view are formed by mirrors.

Recently, these systems for indirect view are increasingly replaced and/or supplemented by cameras and image capturing units, respectively, which are designed such that a camera attached to the outside of the vehicle captures an image of the vehicle environment, which image is then, if necessary after having performed image processing, displayed visible for the driver on a display unit that is mounted in the vehicle interior.

Currently, these cameras and image capturing units, respectively, are fixedly or detachably mounted directly to the vehicle body, i.e. they do not protrude or only slightly protrude from the vehicle body. However, if a camera is mounted to the vehicle in this manner, it is almost impossible to capture lateral fields of view laterally adjacent (next) to the vehicle with similar viewing angles a driver would be provided with when looking in a conventional side mirror, without the use of image capturing units with comparatively strong wide angles. Especially for commercial vehicles it is, however, preferable to visualize a respective plane and horizontal area of the road (pavement), which has a predetermined width and extends from a predetermined distance behind the driver's eye point up to the horizon, on the driver's side as well as on the front passenger's side. When using conventional mirrors a predetermined distance behind the driver's eye point, the width of this area/stripe corresponds to the field of view of a wide-angle mirror; in a shorter distance behind the driver's eye point, it corresponds to the field of view of a main mirror whose predefined visible width, i.e. extension in the transverse direction of the vehicle, is smaller than that of a wide-angle mirror. Displaying these fields of view by means of camera systems, which are directly attached to the vehicle, is difficult. Basically, the relevant regions around the vehicle usually can be more easily captured by means of camera systems if these camera systems are mounted at a distance from the vehicle, e.g. laterally protruding or projecting from the external surface of the vehicle.

Moreover, replacing conventional mirrors of commercial vehicles by camera systems is favourable with regard to air flow and advantageous with regard to fuel consumption as the air flow around the vehicle is not negatively influenced by protruding or projecting mirrors. Recently, however, mirrors have been specifically designed to cause specific flow conditions that have a positive effect on fuel consumption. This targeted effect on the air flow around the vehicle is not possible if the camera of a mirror substitution system is directly attached to the vehicle body.

On the other hand, when providing protruding mountings (fasteners) for a camera monitor system of a vehicle, which system includes the camera and, in particular, the image capturing unit thereof, it may be preferable to mount the same at a position on the vehicle, which position is only poorly directly (or indirectly) visible for a person seated on the driver's seat, in order to achieve an optimum view and orientation of the camera. This means that the mounting of the image capturing unit may not be directly visible for the driver during certain driving manoeuvres, particularly if the mounting position of the camera strongly protrudes from the vehicle and, therefore, does not coincide with the conventional contours of the vehicle, thus posing the risk of collision with the environment or other traffic participants.

In order to protect the camera and image capturing unit, respectively, e.g. DE 10 2012 015 395 B3 discloses a camera arm for a camera of a mirror substitute system of a commercial vehicle, which camera arm comprises a first housing element and a second housing element. The first housing element houses an image capturing unit of the camera of the mirror substitute system and the second housing element is adapted to be positional fixedly connected to the vehicle body. A pivoting mechanism is provided between the first housing element and the second housing element, so that the first housing element is pivotable relative to the second housing element around a pivot axis. In the event of a collision with an obstacle, the first housing element retracts (pivots inward) relative to the second housing element, so that the comparatively expensive camera unit in the first housing element is not damaged and does not absorb the impact.]

### SUMMARY OF THE INVENTION

Based thereon, it is an object of the invention to provide a display system for regions in the environment of a vehicle, in particular commercial vehicle, which allows for an optimum view of the image capturing unit with regard to the respectively demanded or desired field of view, and is provided such that a collision of the image capturing unit with obstacles is prevented.

This object is solved by a display system comprising the features of claim 1. Preferred embodiments are given in the dependent claims.

The invention is based on the idea to provide a display system for regions in the vehicle environment, which display system comprises at least one image capturing unit, a processing unit, and a display unit. The image capturing unit is provided to the vehicle in a housing protruding outward from the vehicle. The housing considerably and widely, respectively, protrudes from the vehicle, usually in lateral direction of the vehicle, i.e. substantially perpendicular to the central plane of the vehicle, which extends in the front-rear-direction of the vehicle. This allows for arranging the image capturing unit such with regard to the vehicle, that the image capturing unit has an optimum view of the region to be captured, i.e. in a commercial vehicle the field of view of a main mirror (field of view II according to ECE regulation R 46) and/or a wide-angle mirror (field of view IV according to ECE regulation R 46). This is made possible due to its distance with regard to the vehicle, which distance is provided by the protruding or projecting housing, which is clearly spaced from the vehicle exterior surface, in particular in the direction perpendicular to the central plane of the vehicle.

Due to the fact that the housing or camera arm widely protrudes or projects from the vehicle, and dependent on the mounting position thereof on the vehicle, a direct view on the housing may not be possible or difficult. The housing may, for example, be mounted at a position above the driver's eye points and/or at a distance behind the driver's eye points at the vehicle, or at another position that is not visible or only poorly directly visible by a person seated on a driver's seat, e.g., depending on the position, also below the eye points. The display system according to the invention therefore additionally comprises a capturing means for the position of the image capturing unit, which enables the driver to readily recognize/identify the position of the image capturing unit relative to the vehicle environment, i.e. without requiring the driver to move from his normal seating position, and without strongly distracting the driver from his direct or indirect view of the traffic. Specifically, the capturing means may display the position of the image capturing unit, e.g. relative to an obstacle for the image capturing unit, to the driver, so that a collision with this obstacle can be prevented. The driver is, thus, able to estimate or check the location and position of the image capturing unit relative to an obstacle in situations that bear the risk of collision, and may thus correspondingly adapt his driving manoeuvres in order to prevent collision.

The display system according to the invention, therefore, does not only offer optimum conditions for positioning the image capturing unit such with regard to the vehicle that the required visible regions may be reliably captured, but also allows for preventing collisions of the image capturing unit with an obstacle, in particular as the image capturing units are expensive and costly to replace in case they are damaged. Moreover, if the image capturing unit is used within a mirror substitute system, it will have to be immediately replaced or repaired in case of a damage, as otherwise the vehicle will no longer meet the requirements regarding traffic safety, so that downtimes of the vehicle may occur.

According to a preferred embodiment, the image capturing unit is arranged in a housing protruding, in particular laterally, from a vehicle side. Thus, the image capturing unit may continuously and reliably capture the legally prescribed fields of view, e.g. the fields of view II and/or IV according to ECE regulation R 46, as required, and may, for example, be used as a mirror substitute system for a main and/or wide-angle mirror. In a preferred embodiment, the housing, which houses the image capturing unit, is arranged on the vehicle in a protruding manner, so that the housing including the image capturing unit is not within the (direct) field of view of the driver of the vehicle. In an alternative embodiment, however, the housing may be arranged partly within the driver's field of view, or appear in the driver's field of view after a corresponding movement of the driver.

Preferably, the capturing means is spatially separated from the image capturing unit and arranged on the vehicle exterior, i.e. the capturing means is not located in or at the housing in which the image capturing unit is arranged. For example, two separate housings, which are spaced apart from each other, may be provided. In one exemplary embodiment, the capturing means is directly mounted to the vehicle. This ensures that the capturing means reliably captures the position of the image capturing unit relative to the vehicle environment while being insusceptible to collisions.

Alternatively, it is also possible to provide the capturing means at the housing in which the image capturing unit is arranged. The image capturing unit and the capturing means thus may, for example, share a common housing and, more preferably, may be arranged immediately adjacent to each other within the housing. This may be of advantage when acquiring distance information between the image capturing unit and the housing, respectively, and an obstacle in the vehicle environment, as it allows for a more precise acquisition of distance information.

In a preferred embodiment, the capturing means comprises a system for indirect view, which, visible for the vehicle driver, captures an image of the image capturing unit and its immediate environment. By means of the system for indirect view of the image capturing unit, the driver of the vehicle may reliably and permanently monitor the distance or space of an image capturing unit with regard to an obstacle, and, thus, the driver may control the vehicle such that a collision of the image capturing unit and the obstacle can be avoided. This is of particular advantage during manoeuvring or parking processes.

The system for indirect view comprises, for example, a camera system and/or a mirror system by means of which the position of the image capturing unit relative to the vehicle environment can be recognized/identified and monitored. The system for indirect view is arranged such that it at least partially captures the image capturing unit and/or the housing in which the image capturing unit is arranged at a spatial distance from the vehicle. If the system for indirect view is a camera system, an evaluation or display unit is additionally provided within the region of perception of the driver as an output means for image data and information obtained from the image data. The image data may be displayed either unprocessed and/or unevaluated or may be analysed by means of image analysis, and only information thus obtained may be output, e.g. in the form of a warning tone, when too closely approaching an obstacle.

Preferably, the system for indirect view is mounted such to the vehicle, in particular commercial vehicle, that, additionally, a legally prescribed field of view around a commercial vehicle is at least partly captured. Therefore, the system for indirect view, on the one hand, allows for identifying the position of the image capturing unit with regard to the vehicle environment and, on the other hand, enables the driver of the commercial vehicle to additionally view a legally prescribed field of view, e.g. the field of view of a ramp mirror (field of view V according to ECE regulation R 46) and/or the field of view of a front mirror (field of view VI according to ECE regulation R 46).

In a preferred embodiment, the system for indirect view is a camera system, and the captured image information thereof is transmitted to the processing unit and the display unit that is visible for the driver of the vehicle, in order to be processed and displayed, respectively. Alternatively, the image information of the capturing means may also be output on a separate display unit, which is separated from the display unit for the image data of the image capturing unit. The image information captured by the camera system may, for example, be processed such, that the image capturing unit to be monitored is graphically highlighted on the images captured by the camera system, e.g. by means of graphic markings and/or symbols. Alternatively or additionally, the image capturing unit contained in the images captured by the camera system may be highlighted by means of image processing, e.g. by colouring, contrast modification, modification of image sharpness, modification of luminance and/or modification of transparency.

Alternatively or additionally, in particular if the system for indirect view is a camera system, the image information captured thereof may be transmitted to a system separate from the above-suggested display system, in order to be processed. This separate system, for example, may be a driver assistance system, which may already exists in the vehicle, and which may comprise a display unit by means of which the image data captured and processed by the camera system may be output to the driver. Alternatively, the information may be transmitted to a vehicle control and be an input to the vehicle control. Finally, a system separate from the display system may be provided in the form of a separate display unit, which displays the data of the capturing means as required, i.e. for example in critical driving situations, and has its own processing unit.

Moreover, the system for indirect view may be adapted to immediately/directly supply the captured image information to the driver of the vehicle. The system for indirect sight may, for example, be a mirror mounted to the vehicle such that the driver of the vehicle can view the image capturing unit by means of this mirror.

In an embodiment according to the invention, the processing unit processing the images of the camera system may be adapted to superimpose a vehicle relation on the image displayed on the display unit, which image contains the image capturing unit. Due to the superimposed vehicle relation, the driver of the vehicle may quickly orientate himself and thus readily realize the position of the image capturing unit with regard to the vehicle environment and the vehicle. Alternatively, the camera unit may be aligned such that at least part of the vehicle is captured, and the processing unit is adapted to have the captured vehicle part at least partially displayed as a vehicle reference on the display image.

In a preferred embodiment, the capturing means is further adapted to capture and determine distance information between the image capturing unit and an obstacle for the image capturing unit within the vehicle environment, e.g. based on image data. Determination of distance information may, for example, be effected by means of a separate distance sensor or, e.g. by evaluation of image data, i.e. without a separate sensor. If a distance sensor is provided, this distance sensor may form the capturing means, or it may be provided in addition to another capturing means. The distance information may then be, e.g. graphically, superimposed on the display image displayed to the driver of the vehicle, a warning signal, e.g. a warning tone, may be output to the driver when falling below a certain distance, and/or the distance information may be submitted to the vehicle control system for further processing. Dependent on the distance information, the vehicle control system may intervene with the vehicle control; e.g. initiate automatic braking. Moreover, the distance information may be further processed by the vehicle control system; the distance information may, for example be used for a parking system of the vehicle. In an alternative embodiment, the capturing means may be adapted to only transmit distance information to the vehicle control system after the distance information shows a value below a critical value.

When transmitting distance information, the capturing means sends a signal indicating the distance information and causing the vehicle control to intervene with the driving parameters of the vehicle by means of a driver assistance system. The driving parameters include, for example, the vehicle speed, the degree of actuation of a brake, and the steering angle of the vehicle. The intervention with the driving parameters may be further dependent on other driving parameters and the driving situation of the vehicle, respectively, wherein the driving situation may be captured/determined, for example, by means of further vehicle sensors like a steering angle sensor, a speed sensor, a braking sensor and the like.

In one embodiment, the capturing means comprises a sensor adapted to capture distance information between the image capturing unit and an obstacle for the image capturing unit within the vehicle environment, and to transmit this information to the vehicle control system if required. The sensor may be a radar sensor or an infrared sensor for capturing/determining the distance information. The sensor may be mounted to the vehicle at a spatial distance from the image capturing unit. Alternatively, the sensor may be mounted on the outmost end of the housing, which protrudes from the vehicle and in which the image capturing unit is arranged, in order to reliably and precisely capture the distance information.

Dependent on the distance information transmitted by the capturing means, the vehicle control system may output an optical signal, e.g. in the form of graphical insertions/overlays, on the display image of the display system, an acoustic signal, e.g. in the form of warning tones in the driver's cabin, and/or a haptic signal, e.g. in the form of a vibration of the steering wheel, to the driver. Due to the signal output to the driver of the vehicle, the driver's attention may be drawn to the obstacle for the image capturing unit at an early stage and, thus, a collision of the image capturing unit and the protruding housing, respectively, with the obstacle can be prevented.

Alternatively or additionally, the capturing means is provided with an information/indication component mounted on the image capturing unit and/or in a defined geometric relation to the image capturing unit, which information/indication component is at least partially visible for the driver of the vehicle. This is of particular advantage if the image capturing unit and/or the housing, which protrudes from the vehicle and in which the image capturing unit is arranged, is/are not visible or only poorly visible for the driver of the vehicle and, thus, is not within the field of view of the vehicle driver. By means of the information/indication component, the driver can identify the position of the image capturing unit with regard to the vehicle environment. The information/indication component may, for example, be a winglet, a protrusion, a fin and/or any other component that may indicate the image capturing unit. The driver may, thus, identify and check the location and position of the image capturing unit in certain critical driving situations by direct view on the information/indication component.

According to a further embodiment of the invention, the capturing means comprises a light source, e.g. a LED, which is positioned such with regard to the image capturing unit that it may project a marking on an obstacle for the image capturing unit in the vehicle environment. The marking on the obstacle enables the vehicle driver to estimate the position of the image capturing unit with regard to the obstacle. The light source is preferably mounted at the housing that protrudes from the vehicle, and is oriented such that a light cone is emitted in the forward driving direction of the vehicle. Preferably, the light source is arranged at the outmost end of the protruding housing and oriented such that an outer border of the light cone is in parallel with the central plane of the vehicle and in alignment with the outmost end of the protruding housing, so that the outer border of the light cone also indicates the outmost end of the protruding housing in which the image capturing unit is arranged. Alternatively, the light source may be arranged such with regard to the image capturing unit, that a shadow of the image capturing unit, or of its housing, or of a shaping (formation) on its housing, is projected on the obstacle.

In a preferred embodiment, the capturing means can be actuated manually or dependent on the driving situation, e.g. during a parking or manoeuvring process of the vehicle. Thus, the driver's attention is only drawn to the image capturing unit in certain critical driving situations, so that the driver is not distracted by the capturing means in driving situations where his attention on the image capturing unit is not required.

Preferably, the image capturing unit comprises a camera and/or an image sensor.

### BRIEF DESCRIPTION OF THE DRAWINGS

In the following, the invention is exemplarily described by means of the attached Figures, wherein

FIG. 1 shows a schematic illustration of a display system;

FIG. 2 shows a schematic illustration of a display system attached to a vehicle, in particular commercial vehicle, and comprising a capturing means;

FIG. 3 shows a schematic illustration of a display system attached to a vehicle, in particular commercial vehicle, and comprising an alternative capturing means;

FIG. 4 shows a schematic illustration of the display system according to FIG. 3, which is attached to a vehicle, in particular commercial vehicle, and wherein the capturing means is arranged at an alternative position;

FIG. 5 shows a schematic illustration of an image of the vehicle environment, which image is captured by the capturing means and displayed on the display unit;

FIG. 6 shows a schematic illustration of an image of the vehicle environment, which image is captured by the image capturing unit and displayed on the display unit;

FIG. 7 shows a schematic illustration of a display system attached to a vehicle, in particular commercial vehicle, and comprising an alternative capturing means;

FIG. 8 shows a schematic illustration of a display system attached to a vehicle, in particular commercial vehicle, and comprising an alternative capturing means;

FIG. 9 shows a schematic illustration of a display system attached to a vehicle, in particular commercial vehicle, and comprising an alternative capturing means.]

### DETAILED DESCRIPTION OF THE PRESENTLY PREFERRED EMBODIMENTS

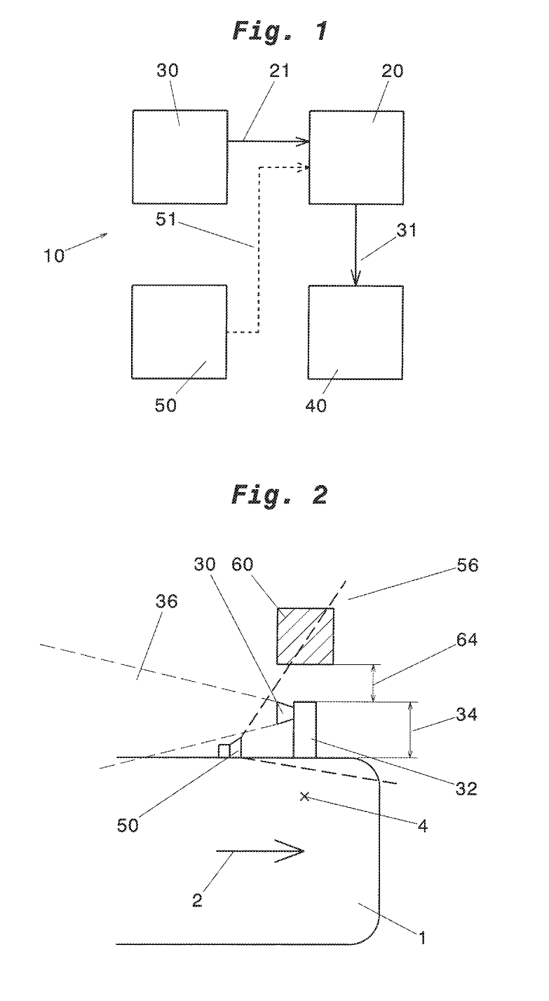

FIG. 1 schematically illustrates a display system 10. The display system 10, which may be used in a commercial vehicle like a truck, comprises at least an image capturing unit 30, a processing unit 20, a display unit 40, and a capturing means 50. The images captured by the capturing unit 30 are submitted to the processing unit 20 via a first connection 21, e.g. a suitable data cable for digital transfer of the images obtained by the processing unit 30. The processing unit 20 may be adapted to convert the captured images into a displayed image in a desired way. The processing unit 20 may, for example, process an image received from the image capturing unit 30 such, that certain traffic objects in the image are recognized/identified and marked. The display image modified by the processing unit 20 is then supplied to the display unit 40 via a second connection 31, e.g. a suitable data cable for digital transfer of images. The display unit 40 is adapted to display the display image in a visible and photorealistic manner for the driver of the commercial vehicle 50.

The processing unit 20 does not necessarily have to process the image captured by the image capturing unit 30. In some embodiments, the processing unit 20 is adapted to supply the image captured by the image capturing unit 30 as a display image to the display unit 40 in an unmodified manner.

As shown in FIG. 1, the display system 10 comprises a capturing means 50, which may be connected to the processing unit 20 via a third connection 51, e.g. a suitable data cable for digital data transfer. The capturing means 50 is adapted to enable the driver of the vehicle to identify the position of the image capturing unit 30 with regard to the vehicle environment.

FIG. 2 schematically shows a plan view of the display system 10 of FIG. 1, which is attached to a vehicle 1. FIG. 2 shows that the image capturing unit 20, e.g. a camera, is mounted to the vehicle 1 in a housing 32 that protrudes outward from the vehicle 1. In the illustrated example, the housing 32 extends from the driver's side of the vehicle 1 with a distance 34. The image capturing unit 30 is preferably mounted to an outmost portion of the housing 32 and aligned such that it contains a field of view 36, which substantially extends opposite to a forward driving direction 2 of the vehicle 1 from forward to rearward, and is mounted substantially behind an eye point 4 of the driver of the vehicle 1. Moreover, FIG. 2 schematically illustrates an obstacle 60 for the image capturing unit 30, e.g. a tree, which obstacle is located at a distance 64 from the outmost end of the housing 32.

In the embodiment shown in FIG. 2, the capturing means is a camera system 50, which is mounted to the vehicle 1 at a spatial distance from the image capturing unit 30. In the forward driving direction 2, the camera system 50 is mounted on the vehicle 1 behind the image capturing unit 30, and is oriented such that it captures a field of view 56 that substantially extends in the forward driving direction 2 of the vehicle 1, and at least partially captures the image capturing unit 30. The image information captured by the camera unit 50 may be transferred to the processing unit 20 and to the display unit 40, which is visible for the driver of the vehicle 1, in order to be processed and displayed, respectively. Instead of a camera system 50, the capturing means may comprise a mirror system, by means of which mirror system the driver of the vehicle 1 may view and monitor the image capturing unit 30.

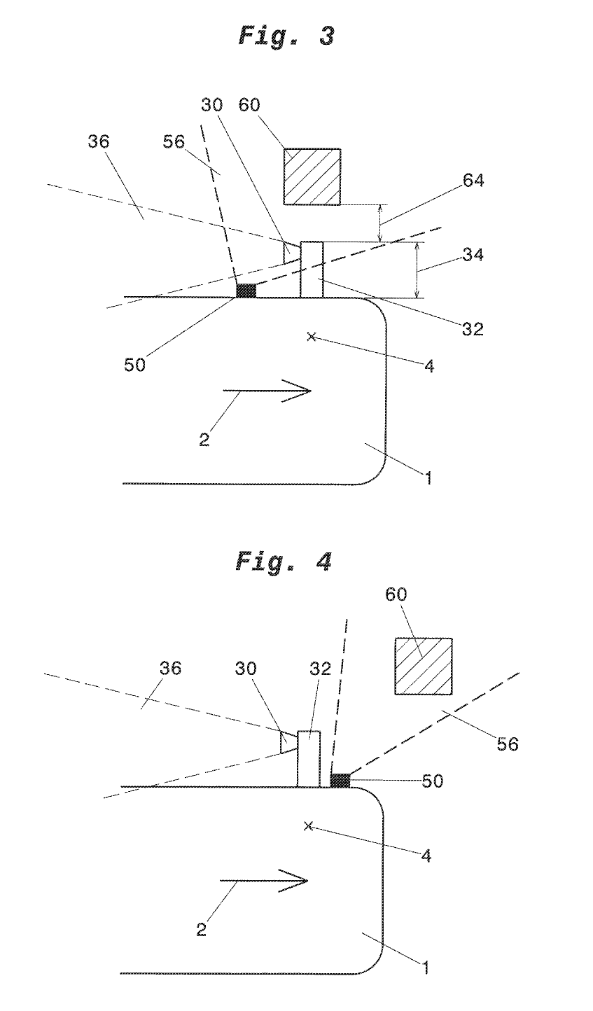

FIG. 3 shows the display system 10 of FIG. 2 with a differently oriented capturing means 50. As illustrated in FIG. 3, the capturing means 50 in the form of a camera system is mounted such to the vehicle that the field of view 56 captured by the capturing means 50 substantially extends perpendicular to the forward driving direction 2, wherein the field of view 56 at least partially covers (contains) the image capturing unit 30 and the associated protruding housing 32, respectively.

Alternatively, the capturing means 50 may be a correspondingly arranged sensor, e.g. a radar or infrared sensor, which is adapted to capture distance information between the vehicle 1 and the obstacle 60, and to supply this information to the processing unit 20. In the example shown in FIG. 3, with regard to the forward driving direction 2, the capturing means 40 is mounted to the vehicle 1 behind the image capturing unit 30, while in the example shown in FIG. 4, with regard to the forward driving direction 2, the capturing means 50, e.g. a radar or infrared sensor, is mounted to the vehicle 1 in front of the image capturing unit 30. The capturing means 50 is respectively mounted on the vehicle 1 at a spatial distance from the image capturing unit 30 and such, that a region 56 adjacent (next) to the vehicle 1 becomes visible.

Knowing the distance 34 and based on the distance information of the sensor 50, the processing unit 20 is adapted to determine a distance 64 between the outmost end of the housing 32 and the obstacle 60, and to provide a corresponding indication to the driver of the vehicle, e.g. in the form of an optical, acoustic and/or haptic signal.

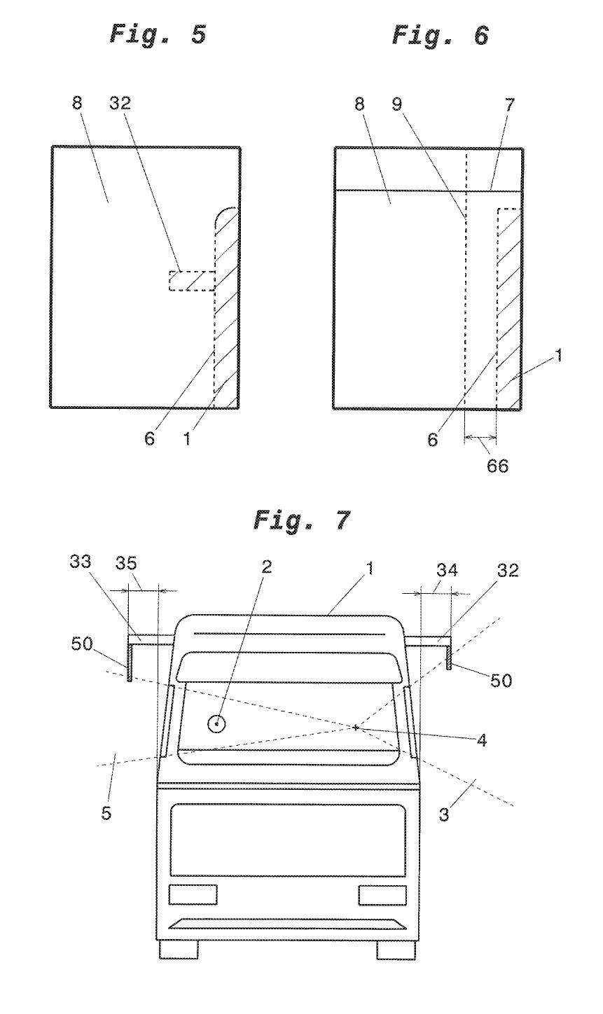

FIG. 5 schematically illustrates a display image displayed on the display unit 40, which image has been captured by the capturing means 50, e.g. the camera unit of FIG. 2. According to the display image of FIG. 5, the camera system 50 is attached to the vehicle in such a manner that it substantially captures a plan view of a road (pavement) 8. The processing unit 20 is adapted to superimpose a vehicle relation 6 on the display image of FIG. 5. Additionally, the processing unit 20 is adapted to schematically superimpose the housing 32, which protrudes from the vehicle 1, on the display image. Alternatively or additionally, it is also possible that the camera system 50 captures at least part of the vehicle 1 and/or the housing 32, which is/are therefore included in the display image, so that the driver of the vehicle may readily orientate himself on the display image.

Referring to FIG. 6, there is schematically illustrated a display image displayed on the display unit 40, which image has been captured by the image capturing unit 30 and, thus, substantially shows a view to the rear; FIG. 6 shows, for example, the horizon 7. The processing unit 20 may further be adapted to superimpose a line 9, for example, dashed, dotted or solid on the display unit, which line is arranged at a distance 66 from the vehicle relation 6 that is also superimposed by the processing unit 20. The distance 66 is intended to qualitatively illustrate the driver the distance 34 between the outmost end of the housing 32 and the vehicle 1, so that the driver may orientate himself by means of the line 9 during manoeuvring processes, and does not accidentally overlook the housing 32 in which the image capturing unit 30 is arranged, and collide with the obstacle 60.

FIG. 7 schematically shows a front view of a vehicle 1, in particular a commercial vehicle. On the driver's side of the vehicle of FIG. 7, the housing 32 is located, which protrudes from the vehicle 1 with a distance 34, and in which the image capturing unit 30 (not explicitly shown in FIG. 7) is arranged. Similarly, a housing 33 protruding with a distance 35 from the vehicle 1 is also located at the front passenger's side, in which housing a further image capturing unit (not explicitly shown in FIG. 7) is arranged.

Further, FIG. 7 illustrated fields of view 3 and 5 of the driver of the vehicle 1, which fields of view the driver may capture laterally adjacent to the vehicle 1, starting from an eye point 4. As illustrated, the position of the eye point 4 is displaced with regard to the center of the vehicle and, thus, the fields of view 3 and 5 are asymmetric with regard to the center of the vehicle. This means that the driver may capture a larger field of view 3 on the driver's side than on the front passenger's side (field of view 5).

Due to the high mounting position of the two housings 32, 33 at the vehicle, the driver of the vehicle 1 cannot directly capture the two housings 32, 34 in his fields of view 3, 5. Therefore, a capturing means 50 in the form of indication components, e.g. downwardly extending fins, is mounted on each of the housings 32, 33, which indication components are adapted to at least partially protrude into the respective field of view 3, 5, to thereby allow the driver to identify the position of the image capturing unit 30 with regard to the vehicle environment. The indication components 50 are preferably mounted on the outmost end of the respective housing 3, 5.

FIG. 8 shows a further display system 10 comprising an alternative capturing means 50. Here, the capturing means 50 is a light source mounted to the housing 32, which light source is adapted to emit a light cone substantially in the forward driving direction 2. The light cone 56 is oriented such that its outer border 57 substantially extends in parallel with the forward driving direction 2, and is in alignment with the outmost end of the housing 32. Thus, the outer border of the light cone 56 represents the outer border of the housing 32.

If the light cone 56 hits an obstacle 60 for the image capturing unit 30, which is arranged in the housing 32, a projected surface 52 having a width 54 arises on the obstacle 60. The width 54 indicates the driver that the housing 32 still has a corresponding overlapping width with the obstacle 60 and, thus, that the housing 32 will collide with the obstacle 60 when driving on. If the light cone 56 does not hit any obstacle 60, the driver realizes that there is no danger of collision between the housing 32 and the obstacle 60.

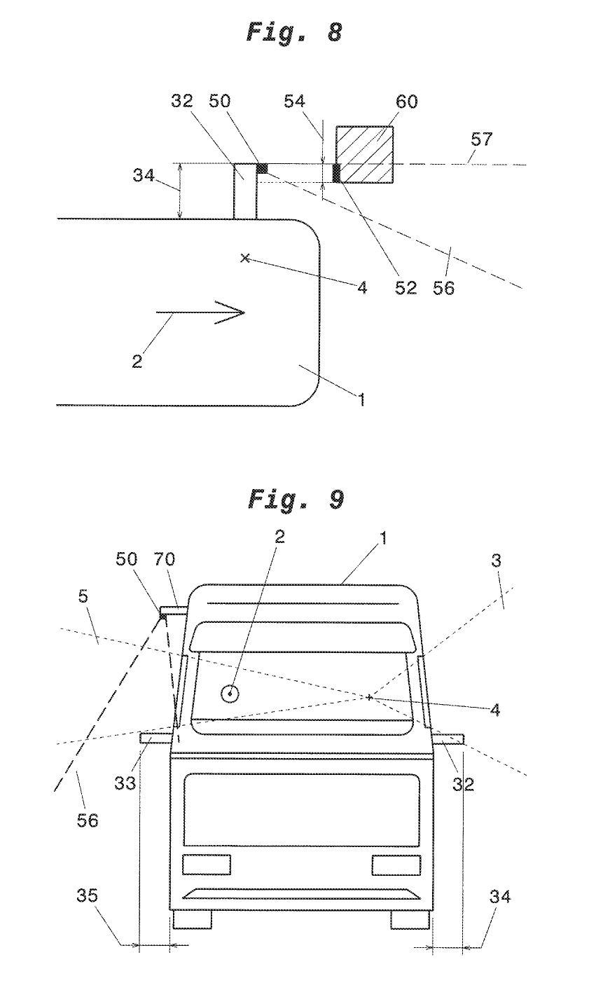

FIG. 9 schematically shows a front view of a vehicle 1, in particular commercial vehicle. In FIG. 9, the housing 32, in which the image capturing unit 30 (not explicitly illustrated in FIG. 7) is arranged, is located on the driver's side and protrudes from the vehicle 1 with a distance 34. Similarly, a housing 35, in which a further image capturing unit (not explicitly illustrated in FIG. 7) is arranged, is located on the front passenger's side, and protrudes from the vehicle with a distance 35. Contrary to FIG. 7, the housings 32, 33 of the embodiment shown in FIG. 9 are mounted to the vehicle 1 below the eye point 4.

FIG. 9 further illustrates the fields of view 3 and 5 of the driver of the vehicle 1, which fields of view the driver can capture laterally adjacent to the vehicle 1 starting from his eye point. As shown, the position of the eye point 4 is displaced with regard to the vehicle center and, thus, the fields of view 3 and 5 are asymmetric with regard to the vehicle center. This means that the driver may capture a larger field of view 3 on the driver's side than on the front passenger's side (field of view 5).

Due to the low mounting position of the two housings 32, 33 on the vehicle 1, and due to the asymmetric seating position of the driver of vehicle 1 with regard to the vehicle center, the driver of vehicle 1 may capture the housing 32 on the driver's side in his field of view 3; the driver of vehicle 1 can, however, not directly capture the housing 34, which is mounted on the front passenger's side, in his field of view 5. Therefore, in the embodiment of FIG. 9, a capturing means 50 is provided in a housing 70 at the vehicle 1, which housing extends outward from the vehicle. The housing 70 is, for example, mounted above the housing 33 and above the eye point 4 on the passenger's side of the vehicle 1. In the embodiment of FIG. 9, the capturing means 50 is, for example, a camera system, which is oriented such in the housing 70 that it captures a field of view 56 that substantially extends vertically downward and contains the housing 33, in which an image capturing unit 30 is arranged. With the help of the capturing means 70, the driver of the vehicle 1 may reliably monitor the housing 33 and the image capturing unit 30, which is arranged therein, and take them into account during manoeuvring and turning processes.

Apart from monitoring the housing 33 arranged on the front passenger's side, the capturing means 50, which is a camera system in FIG. 9, may additionally be adapted to at least partially capture a legally prescribed field of view. The camera system 50 may, for example, additionally capture at least part of the field of view of a ramp mirror (field of view V according to ECE regulation R 46) and/or the field of view of a front mirror (field of view VI according to ECE regulation R 46).

### LIST OF REFERENCE NUMERALS

1 vehicle
2 forward driving direction
3 field of view of the vehicle driver
4 eye point
5 field of view of the driver of the vehicle
6 vehicle reference
7 horizon
8 road (pavement)
9 line
10 display system
20 processing unit
21 first connection
30 image capturing unit
31 second connection
32 housing
33 housing
34 distance
35 distance
36 field of view of image capturing unit
40 display unit
50 capturing means
51 third connection
52 projected area
54 distance
56 field of view/light cone of capturing means
60 obstacle
70 housing

1. A display system for environment regions of a vehicle, comprising:
at least an image capturing unit arranged at the vehicle in a housing outwardly protruding from the vehicle,
a processing unit,
a display unit providing and outputting vehicle environment information captured by the image capturing unit to the driver, and
a capturing means for the position of the image capturing unit, which capturing means enables the driver to identify the position of the image capturing unit with regard to the vehicle environment.

2. The display system according to claim 1, wherein the image capturing unit is arranged in a housing, which protrudes, substantially laterally, from a vehicle side.

3. The display system according to claim 1, wherein the capturing means is arranged at a spatial distance from the image capturing unit on the outside of the vehicle.

4. The display system according to claim 3, wherein the capturing means comprises a system for indirect view, configured to capture an image of the image capturing unit and the immediate environment thereof, which is visible for the driver of the vehicle.

5. The display system according to claim 4, wherein the system for indirect view is a camera system and/or a mirror system.

6. The display system according to claim 4, wherein the vehicle is a commercial vehicle and the system for indirect view at least partially captures a legally prescribed field of view around a commercial vehicle.

7. The display system according to claim 5, wherein the system for indirect view is a camera system, and for processing and displaying, the image information captured by the camera system is transmitted to the processing unit and the display unit, which is visible for the driver of the vehicle.

8. The display system according to claim 1, wherein the processing unit processing the image captured by the camera unit is adapted to superimpose a vehicle reference on the image displayed on the display unit and comprising the image capturing unit.

9. The display system according to claim 1, wherein the processing unit is adapted to provide the driver with an image of the vehicle environment on the display unit, and wherein the capturing means and/or the processing unit is/are adapted to superimpose a marking indicating the position of the image capturing unit on the displayed image.

10. The display system according to claim 1, wherein the capturing means is adapted to capture distance information between the image capturing unit and an obstacle for the image capturing unit located in the vehicle environment, and to supply this information to the vehicle control system.

11. The display system according to claim 10, wherein, if a distance information indicating an obstacle is provided, the processing unit is adapted to transmit a signal to the vehicle control system causing the vehicle control system to intervene in driving parameters of the vehicle by means of a driver assistance system.

12. The display system according to claim 10, wherein the capturing means comprises a sensor adapted to capture distance information between the image capturing unit and an obstacle for the image capturing unit located in the vehicle environment, and to supply this information to the vehicle control system.

13. The display system according to claim 1, wherein the capturing means is an indication component visibly for the driver of the vehicle fixed at the image capturing unit and/or at a defined geometric relation with regard to the image capturing unit.

14. The display system according to claim 13, wherein the indication component is a winglet, a protrusion and/or a fin.

15. The display system according to claim 1, wherein the capturing means is a light source positioned such with respect to the image capturing unit, that it is adapted to project a marking on an obstacle for the image capturing unit in the vehicle environment, for enabling the driver of the vehicle to estimate the position of the image capturing unit with regard to the obstacle.

16. The display system according to claim 1, wherein the capturing means can be activated manually and/or dependent on the driving situation.

17. The display system according to claim 1, wherein the image capturing unit comprises a camera and/or an image sensor.

18. The display system according to claim 1, wherein the image capturing unit at least partially captures a legally prescribed field of view around a commercial vehicle.
